(19) United States
(12) Patent Application Publication
(10) Pub. No.: US 2021/0065111 A1
(43) Pub. Date: Mar. 4, 2021

(54) SYSTEMS AND METHODS FOR ITEM DELIVERY USING A MOBILITY-AS-A-SERVICE SYSTEM

(71) Applicants: Toyota Motor Engineering & Manufacturing North America, Inc., Plano, TX (US); Toyota Motor North America, Inc., Plano, TX (US)

(72) Inventors: Lucas D. Smith, Frisco, TX (US); Shalini Keshavamurthy, Sunnyvale, CA (US); Gagandeep Singh Saini, Plano, TX (US); Louis A. Brugman, Frisco, TX (US); Katsumi Nagata, Foster City, CA (US)

(21) Appl. No.: 16/552,407

(22) Filed: Aug. 27, 2019

(51) Int. Cl. G06Q 10/08; H04W 4/029

(52) U.S. Cl. CPC G06Q 10/08355; H04W 4/029; G06Q 10/0833

(57) ABSTRACT

Systems, methods, and other embodiments described herein relate to tracking a user, updating a destination for the user and delivering an item to the updated destination using a Mobility-as-a-Service (“MaaS”) system.

In one embodiment, a method includes associating the item with the user. The method includes determining a destination of the user, determining a delivery route for the item based at least on the destination and initiating delivery of the item based on the determined delivery route. The method further includes tracking movements of the user, receiving user movement data based on at least the tracked movements of the user, and determining whether the destination has changed based on the user movement data. If the destination has changed, updating the destination based on the user movement data, determining a revised delivery route for the item based on the updated destination, and rerouting the item based on the revised delivery route.

### TECHNICAL FIELD

The subject matter described herein relates, in general, to systems and methods for item delivery, and more particularly, dynamically determining a destination of a user and delivering an item to the destination using a Mobility-as-a-Service system.

### BACKGROUND

Ride sharing services such as Mobility-as-a-Service (“MaaS”) and Transportation-as-a-Service (“TaaS”) provide transportation-on-demand services. Such services provide transportation for people as well as for items. For example, ride-sharing services can transport people along with their luggage to a desired destination. However, sometimes, it may be more efficient or a person may desire that he or she travel separately from his or her luggage. Some current systems, for example, permit ride-sharing services to provide transportation for luggage separate from the person by providing the person's predetermined destination. Since a predetermined destination is required, however, a change in the destination of the person while the luggage is en route may lead to the luggage being delivered to a destination that differs from a person's new destination.

### SUMMARY

In one embodiment, a method for delivering an item, using a MaaS system is disclosed. The method includes associating the item with a user and determining a destination of the user. The method also includes determining a delivery route for the item based at least on the destination, and initiating, using a MaaS vehicle, delivery of the item based on the determined delivery route. The method also includes tracking movements of the user, receiving user movement data based on at least the tracked movements of the user, and determining whether the destination of the user has changed based on user movement data. The method also includes, if the destination of the user has changed, updating the destination of the user based on the user movement data, determining a revised delivery route for the item based on the updated destination, and rerouting the item based on the revised delivery route.

In one embodiment, a MaaS system for delivering an item is disclosed. The MaaS system includes a user tracking device, configured to track movements of a user, one or more processors, and a memory communicably coupled to the one or more processors. The memory stores an item association module including instructions that when executed by the one or more processors cause the one or more processors to associate the item with the user, a user destination module including instructions that when executed by the one or more processors cause the one or more processors to determine a destination of the user, and an item delivery module including instructions that when executed by the one or more processors cause the one or more processors to determine a delivery route for the item based at least on the destination and initiate delivery of the item based on the determined delivery route. The user destination module further includes instructions that when executed by the one or more processors cause the one or more processors to receive user movement data based on at least the tracked movements of the user, determine whether the destination of the user has changed based on user movement data, and if the destination of the user has changed, update the destination of the user based on the user movement data. The item delivery module further includes instructions that when executed by the one or more processors cause the one or more processors to, if the destination of the user has changed, determine a revised delivery route for the item based on the updated destination and reroute the item based on the revised delivery route.

In one embodiment, a non-transitory computer-readable medium for delivering an item, using a MaaS system and including instructions that when executed by one or more processors cause the one or more processors to perform one or more functions is disclosed. The instructions include instructions to associate the item with a user, determine a destination of the user, determine a delivery route for the item based at least on the destination, and initiate, using a MaaS vehicle, delivery of the item based on the determined delivery route. The instructions further include instructions to track movements of the user, receive user movement data based on at least the tracked movements of the user, determine whether the destination of the user has changed based on user movement data, and if the destination of the user has changed, update the destination of the user based on the user movement data, determine a revised delivery route for the item based on the updated destination; and reroute the item based on the revised delivery route.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a networked environment in which systems and methods for item delivery using a MaaS system may be implemented.

FIG. 2 illustrates one embodiment of the MaaS system illustrated in FIG. 1.

FIG. 3 illustrates one embodiment of a flow diagram of a method for item delivery.

FIGS. 4A-4C illustrate examples of item delivery when the destination of the user changes and the item is rerouted.

### DETAILED DESCRIPTION

Systems, methods, and other embodiments associated with a manner of tracking a user, updating a destination for the user and delivering an item to the updated destination using a Mobility-as-a-Service (“MaaS”) system are disclosed. As noted above in some current systems, delivering an item without tracking the user may lead to the item being delivered to a destination that differs from where the user is located.

Accordingly, in one embodiment, the disclosed approach includes permitting a user to check in an item, via a MaaS system, using a user device (e.g., a computer or mobile device). The MaaS system then associates the item with the user. The user may also input a destination of the user (e.g., a hotel). The disclosed approach then determines a delivery route from a point of origin (e.g., a user's home) to the destination and initiates a delivery process by requesting a MaaS vehicle pick-up the item from the point of origin. The MaaS system may determine a route to the destination for the user, which may or may not include MaaS vehicles, as the user may travel using MaaS vehicles, non-MaaS vehicles or both. Further, the MaaS system may track the user's movements, and based on the determined route for the user and the user movements, the MaaS system may determine whether the destination of the user has changed. If the MaaS system determines the destination of the user has changed, the MaaS system updates the destination of the user, determines a revised delivery route for the item based on the updated destination and reroutes the item based on the revised delivery route. However, in a case where the route the user takes to the destination changes dynamically enroute but the destination remains the same, the MaaS system will maintain the delivery route for the item to the destination.

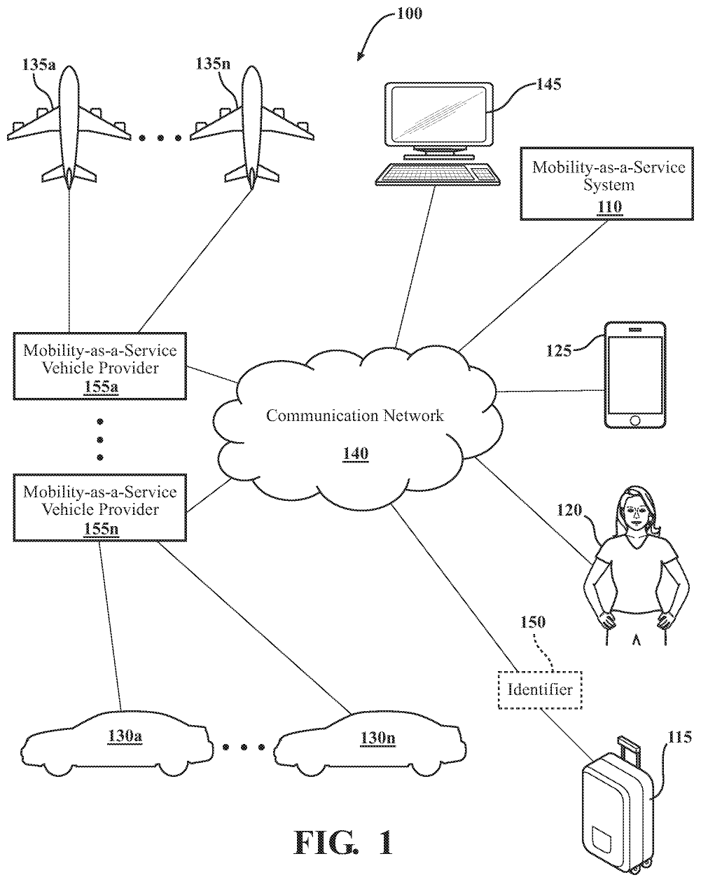

As illustrated in FIG. 1, an example of an item delivery network 100 includes a MaaS system 110 that associates an item 115 with a user 120 (e.g., a person) via one or more communication networks 140, determines a destination for the user 120, and determines a delivery route for the item 115 to the destination using a MaaS vehicle (e.g., MaaS vehicles 130a . . . 130n, collectively known as 130, and MaaS vehicles 135a . . . 135n, collectively known as 135). The MaaS system 110 then tracks the user 120, determines whether the destination of the user 120 has changed and if the destination of the user 120 changes, updates the destination for the user 120 and the delivery route for the item 115. Although illustrated as a standalone system, the MaaS system 110 may fully or partially be located in, as an example, a vehicle, a mobile device, or other suitable device.

The item delivery network 100 may include a computing device 145 that provides an interface between the user 120 and the MaaS system 110 using as an example, an application. Via the computing device 145, the user 120 can check in an item 115 so that the item 115 can be associated with the user 120. The computing device 145 may assign an identifier 150 to the item 115 to link the item 115 to the user 120. The computing device 145 may print or embed the identifier 150 into an object such as a sticker, a label or a tag that the user 120 can affix to the item 115. The identifier 150 may have a combination of letters, numbers and/or symbols such as a QR code. The identifier 150 may include user identifying data such as a user identification, an account number, a user name, a flight number, an address and/or a telephone number in various formats (e.g., physical tag, digital tag, Bluetooth Low Energy tag, etc.). The identifier 150 may identify a place of origin and a destination. As an example, the identifier 150 may be a duplex communication-capable identification token, such as a Radio Frequency Identification (RFID) tag, that links the item 115 to the user 120. In such an example, the RFID tag may be linked to the user's travel itinerary such that an update in the itinerary is communicated to the RFID tag via an RF communication network employing impulse radio technology within the MaaS vehicle (e.g., MaaS vehicles 130, 135) or an appropriate RF hub.

The computing device 145 may be any suitable device including, for example, a desktop computer, a cellular telephone, a smart phone, a personal digital assistant (“PDA”), or a tablet computer. The computing device 145 may have communication capability such that the computing device 145 can transmit and receive data from a plurality of components. Further, the computing device 145 may be used for tracking the user 120 and the item 115.

Additionally and/or alternatively, the item delivery network 100 may include a user tracking device 125, that can track movements of a user 120 and communicate those movements via the communication network 140. The user tracking device 125 may be any suitable device including, for example, a cellular telephone, a smart phone, a personal digital assistant (“PDA”), a tablet computer, a fitness tracker, an activity tracker, or a handheld device having wireless connection capability. The user tracking device 125 may be carried by the user 120. In one or more arrangements, the user tracking device 125 can be worn by the user 120 as a wearable device. For instance, the user tracking device 125 can also be be a smart watch, smart eye glasses, smart jewelry (e.g., necklace, earrings, bracelets, etc.), smart bags, smart shoes, and/or smart clothing (e.g., a shirt, hat or other article of clothing enabled for wireless communication). The functionality described herein pertaining to the computing device 145 and the user tracking device 125 may be carried out by the computing device 145, the user tracking device 125, or both.

The user tracking device 125 may include, for example, a navigation system such as a Global Positioning System (GPS) that identifies the global positioning of the user tracking device 125 and the user 120 carrying the user tracking device 125. Based on the global positioning of the user tracking device 125, the GPS may determine the user's movements and provide the user's movements to the MaaS system 110.

The user's movements may also be tracked using other techniques. For example the user 120 may input his/her current location directly into the user tracking device 125, such as an address. As another example, the user tracking device 125 may monitor a user's status from a database entry. For example, the user's status may be retrieved from an entry in an air travel database that is updated when the user 120 checks in, when a flight of the user 120 departs and/or when the flight of the user 120 arrives. In other aspects, the database may be a water travel database, and/or a ground travel database (such as train travel, taxicab and other travel systems).

The item delivery network includes MaaS vehicle providers 155a, . . . 155n (collectively known as 155). MaaS vehicle providers 155 are entities associated with MaaS vehicles (such as MaaS vehicles 130, 135). As shown in FIG. 1, a first MaaS vehicle provider 155a may be associated with a first set of MaaS vehicles 130a, . . . 130n (e.g., automobiles), and an nth MaaS vehicle provider 155n may be associated with an nth set of MaaS vehicles 135a, . . . 135n (e.g., airplanes). As one option, the MaaS providers 155 may own and operate a fleet of vehicles, which may be autonomous or manually-driven. As another option, the MaaS providers 155 may have employees or contractors with rental, ride-share or contractor-owned vehicles. As another option, the MaaS providers 155 may be connected to other transportation providers such as mass transportation providers like bus companies, train companies, cycling services, ferry companies and airline companies as well as courier services. In the aforementioned options, as an example, the MaaS providers 155 may include a database for monitoring the locations of the MaaS vehicles 130, 135 and may further include a network for communicating with the MaaS vehicles 130, 135 as well as the MaaS system 110 via the communication network 140.

The MaaS vehicles are any vehicle that the MaaS system 110 can connect with via the communication network 140 and the MaaS vehicle providers. To further explain, where the MaaS system 110 can identify a vehicle (e.g. a type and capacity of the vehicle), identify the location of the vehicle in a database, and access the vehicle's schedule (e.g., place and time of departure, place and time of arrival), the vehicle may be referred to as a MaaS vehicle. As an example, MaaS vehicles may include airplanes 130, automobiles 135, motorcycles, bicycles, trains, buses, boats, ferries, etc.

The MaaS system 110 may log relevant data using blockchain. As an example, when the MaaS system 110 determines a route to the destination for the user 120, the MaaS system 110 may also log that route in a blockchain ledger. As another example, data in the identifier 150 may be logged in a blockchain ledger such that it is tracked securely. As another example, any vehicle the user 120 travels with may log its location and its route in a blockchain ledger and the user tracking device 125 may access the blockchain ledgers to determine the user's movements. Additionally and/or alternatively, the MaaS providers 155 may log the locations and activities of the MaaS vehicles using blockchain.

As mentioned above, the MaaS system 110 may associate the item 115 with the user 120 using the computing device 145 and the identifier 150. Then, the MaaS system 110 determines a delivery route for the item 115 to the destination based on the availability of MaaS vehicles as well as the route associated with each MaaS vehicle. The MaaS system 110 tracks the user 120 based on the user's movements received from the user tracking device 125 or any other suitable device. Based on the user's tracked movements, the MaaS system 110 determines whether the destination of the user 120 has changed. In a case where the destination of the user 120 has changed, the MaaS system 110 updates the destination for the user 120 and determines an updated delivery route for the item 115 based on the available MaaS vehicles.

Although in another embodiment, the item 115 may be an inanimate object such as a piece of luggage. Alternatively, the item 115 may be animate such as a person or a pet. In such an embodiment, the MaaS system 110 may track the user 120, update the destination of the user 120, and deliver the inanimate or animate item 115 to the user's destination.

Although the user 120 has been described thus far as a person, in another embodiment, the user 120 may be an inanimate object or another type of animate object (e.g., pet). In this case, if the destination of the inanimate object or another type of animate object changes, the destination can be updated and the item 115 can be delivered to the updated destination. In other words, the MaaS system 110 may track a first object, which may be animate such as a person/user or inanimate such as a piece of luggage. Then, the MaaS system 110 may determine and update a destination for the first object and deliver a second object, which may be animate or inanimate, to the destination (updated or otherwise) of the first object using the MaaS system 110.

The various components of item delivery network 100 can be communicatively linked through one or more communication networks 140. As used herein, the term “communicatively linked” can include direct or indirect connections through a communication channel or pathway or another component or system. A “communication network” means one or more components designed to transmit and/or receive information from one source to another.

The one or more communication networks 140 can be implemented as, or include, without limitation, a wide area network (WAN), a local area network (LAN), the Public Switched Telephone Network (PSTN), a wireless network, a cellular mobile network, a Virtual Private Network (VPN), a mesh network, the Internet, and/or one or more intranets. The communication network 140 further can be implemented as or include one or more wireless networks, whether short or long range. The communication network 140 can include wired communication links and/or wireless communication links. The communication network 140 can include any combination of networks. The communication network 140 can include one or more routers, switches, access points, wireless access points, and/or the like.

The user tracking device 125, the MaaS system 110, the MaaS vehicles 130, 135, the object (e.g., RFID tag) affixed to the item 115, and/or the computing device 145 can include and/or execute suitable communication software, which enables the user tracking device 125, the MaaS system 110, the MaaS vehicles 130, 135, the identifier 150, and/or the computing device 145 to communicate with each other through the communication network 140 and perform the functions disclosed herein.

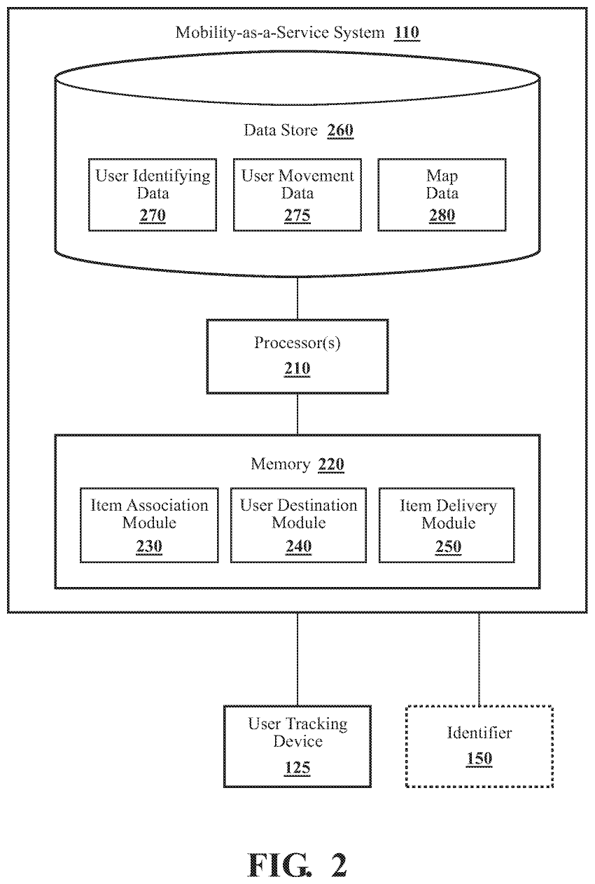

Referring to FIG. 2, the MaaS system 110 is shown as including a processor 210. The processor 210 may be part of the MaaS system 110 as shown, or the processor 210 may be separate from the MaaS system 110 and the MaaS system 110 may access the processor 210 through a data bus, the communication network 140 or another communication path. In one or more embodiments, the processor 210 is an application specific integrated circuit that is configured to implement functions associated with an item association module 230, a user destination module 240, and an item delivery module 250. In general, the processor 210 is an electronic processor such as a microprocessor that is capable of performing various functions as described herein.

In one embodiment, the MaaS system 110 includes a memory 220 that stores the item association module 230, the user destination module 240, and the item delivery module 250. The memory 220 may be a random-access memory (RAM), read-only memory (ROM), a hard disk drive, a flash memory, or any other suitable memory for storing the item association module 230, the user destination module 240, and the item delivery module 250. The item association module 230, the user destination module 240, and the item delivery module 250 are, for example, computer-readable instructions that when executed by the processor 210 cause the processor 210 to perform the various functions disclosed herein.

Furthermore, in one embodiment, the MaaS system 110 includes a data store 260. The data store 260 is, in one embodiment, an electronic data structure, such as a database, that is stored in the memory 220 or another memory and that is configured with routines that can be executed by the processor 210 for analyzing stored data, providing stored data, organizing stored data, and so on. Thus, in one embodiment, the data store 260 stores data used by the modules 230, 240 and 250 in executing various functions. In one embodiment, the data store 260 includes user identifying data 270, user movement data 275, and map data 280 along with, for example, other information that is used by the modules 230, 240 and 250. In one embodiment, the data store 260 is a ledger in blockchain or combination of database, cloud server, ledger, etc.

The user identifying data 270, as described above, includes any relevant information about the user 120. The user movement data 275 includes information about the user's movement and location tracked by the user tracking device 125. The map data 280 includes data that the MaaS system 110 can use to determine a location and a route of travel for the item 115. In other words, the map data 280 is a map that includes an originating location for the item 115, a destination for the user 120, and/or available routes of travel. The map data 280 also could be a collection of logistic points or location identified points that are virtually created and associated with physical locations.

The item association module 230 generally includes instructions that when executed by the one or more processors 210 cause the one or more processors 210 to associate the item 115 with the user 120. As an example, the user 120 may check in an item 115 by first opening an application related to the MaaS system on the computing device. Then, the user may input any relevant information (e.g., the user's information and item information) into the MaaS system-related application. The user's information may include the user's name and destination, and the item information may include the number of items to be checked in, the sizes of the items, and/or any transportation restrictions such as no air travel.

Upon receiving information about the user and the item, the item association module 230 associates the item 115 with the user 120 by, for example, assigning an identifier 150 to the item 115. The identifier 150 may be letters, numbers and/or a QR code. After assigning each item 115 an identifier 150, the item association module 230 may send a signal to the computing device 145 to output the identifier 150 onto a suitable label or tag that can be affixed to the item 115 in the MaaS system 110. As an example, the computing device may print the identifier onto the label or tag. As another example, the computing device may embed the identifier in the label or tag.

In one embodiment, the item association module 230 may assign the identifier 150 to the item 115 when the item 115 is being checked in by user 120 and physically received into a MaaS vehicle for transportation. In another embodiment, the item association module 230 may assign the identifier 150 to the item 115 prior to the item 115 being received into a MaaS vehicle. n such an embodiment, as an example, the user 120 may check in at home and print the identifier 150 on a label or tag from the user's printer.

The user destination module 240 generally includes instructions that when executed by the one or more processors 210 cause the one or more processors 210 to determine a destination of the user 120. The user destination module 240 may determine the destination of the user 120 based at least on user input. As an example, the user 120 may input the destination of the user 120 into the application on the computing device 145. As another example, the user 120 may input a travel itinerary into the application on the computing device 145 and the application may extract the destination of the user 120 based on the inputted itinerary.

The user destination module 240 receives user movement data 275 from the user tracking device 125 and determines whether the destination of the user 120 has changed based on the user movement data 275. The user movement data 275 may include a present location of the user 120, time spent at the location, points of interest proximate to the present location, activities generally engaged in at the points of interest, user speed (e.g., to determine if the user 120 is sitting/standing, walking, on a bicycle, a train or an airplane), travel itinerary, which as an example, may include embarkation and debarkation from an airplane, a train and/or a ferry.

The user destination module 240 may compare the user movement data 275 to the route of the last recorded destination to determine if the user 120 is moving towards the last recorded destination. If the user 120 is not moving towards the last recorded destination, the user destination module 240 may determine that the user's destination has changed. As an example, based on the last recorded destination, the user destination module may determine that the user should be travelling southward to reach the destination. However, if the user destination module 240 detects, based on the user movement, that the user is travelling northward, the user destination module may determine that the destination of the user has changed.

If the destination of the user 120 has changed, the user destination module 240 may update the destination of the user 120 based on various factors such as the user movement data 275, the last recorded destination and/or the user's travel history. In other words, the user destination module 240 may predict a new destination based on factors such as the route the user 120 is traveling on, the type of transportation (e.g., automobile, airplane, train, etc.) the user 120 is using, and places the user 120 has visited in the past. As an example, based on the user movement data 275, the user destination module 240 may determine that the user 120 is in a boat heading toward a remote island. Upon identifying that the boat is headed to the remote island, the user destination module 240 may consider other factors such as whether there are any possibilities that the user 120 may be going elsewhere, taking a detour, and/or whether the user 120 has travelled to the remote island before. As an option, after narrowing down the possible destinations or identifying a single possible destination, the user destination module 240 may present the possible destinations to the user 120 and request verification or query the user 120 for an updated destination with the user tracking device 125. As another option, the user destination module 240 may determine and update to the new destination without user input, using various factors previously listed and any other relevant information.

The item delivery module 250 generally includes instructions that when executed by the one or more processors 210 cause the one or more processors 210 to determine a delivery route for the item based at least on the destination of the user 120 and to initiate delivery of the item 115 based on the determined delivery route. In a case where the destination of the user 120 changes and the user destination module 240 predicts and/or determines an updated destination, the item delivery module 250 determines a revised delivery route and reroutes item 115 based on the revised delivery route.

The item delivery module 250 may determine a route of travel for the item 115 by identifying a point of origin (based on a present location of the item 115), a destination (based on the destination of the user 120) and various routes or paths connecting the two. As an example, the item delivery module may use the map data to identify a street closest to the point of origin, a street closest to the destination and any streets running between the two locations. In general, the item delivery module may then use any suitable mapping or navigational algorithm to determine a route of travel, taking into account accessible streets and various modes of transportation.

Upon determining the route of travel from the point of origin to the destination, the item delivery module 250 may then partition the route into one or more sub-routes, where each sub-route covers a portion of the route. Each sub-route may utilize any mode of transportation such as by train, automobile, bicycle, ferry, on foot, and/or airplane. In other words, the sub-route may include at least one of a ground travel route, an air travel route and a water travel route. The item delivery module 250 may identify an available mode of transportation to travel each sub-route. The available modes of transportation may be located in a map database, accessible by the MaaS system 110 and specifically, the item delivery module 250. Each mode of transportation located in the map database may be identified as a MaaS vehicle, as explained below.

In a case where the item delivery module 250 is unable to identify an available mode of transportation to travel a sub-route, the delivery route may partition the sub-route into smaller sub-routes or re-route a portion of the route of travel. In addition to determining the route based on the destination and the available modes of transportation for each sub-route, the item delivery module 250 may determine the route based on a desired delivery period, a desired time of arrival, cost of delivery, or travel mode limitation (such as only ground transportation may be utilized).

In a case where the destination is updated, the item delivery module may determine a revised route of travel. When the revised route of travel is determined, the item delivery module 250 may reroute the item 115 based on the revised route of travel by identifying the current location of the item 115 and notifying both the MaaS vehicle and/or the driver currently transporting the item 115 of the change in route as well as the MaaS vehicle identified to pick up the item 115.

After determining the route of travel (original or revised), the item delivery module 250 initiates delivery of the item 115 based on the determined route of travel. The item delivery module 250 identifies a first sub-route and an available MaaS vehicle available to travel along the first sub-route. Upon identifying the available MaaS vehicle, the item delivery module 250 notifies the available MaaS vehicle, in the case of an autonomous vehicle, and/or notifies a driver of the MaaS vehicle of an item pick-up. Notifying certain MaaS vehicles such as a train or a plane may include purchasing a boarding pass to travel on the MaaS vehicle.

The number of times that the user destination module 240 updates the destination of the user 120 and the number of times that the item delivery module 250 determines a revised delivery route and reroutes the item 115 is not limited. As such, if the destination of the user 120 changes multiple times, the user destination module 240 may update the destination of the user 120 based on the user movement data 275 for each time the destination changes. Further, the item delivery module 250 determines the revised delivery route for the item 115 based on the updated destination and reroutes the item 115 based on the revised delivery route each time.

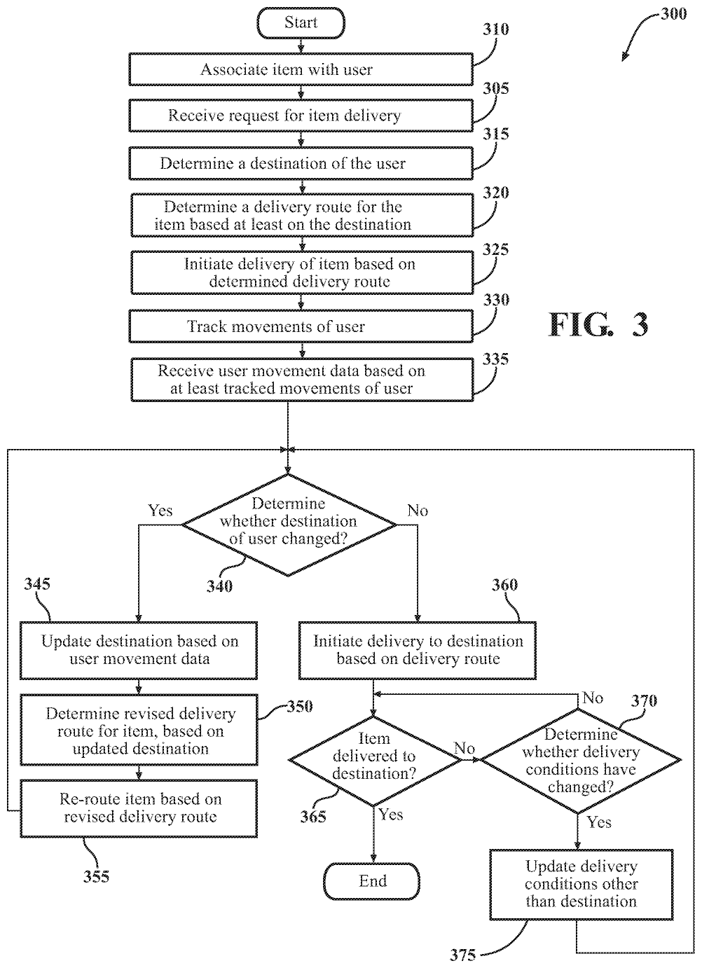

Referring now to FIG. 3, an example of a process of determining a destination of a user 120 based on tracking the user 120, and delivering item 115, using a MaaS system 110, to the destination is shown. Various possible steps of process 300 will now be described. The process 300 illustrated in FIG. 3 may be applicable to the embodiments described above in relation to FIGS. 1 and 2, but it is understood that the process 300 can be carried out with other suitable systems and arrangements. Moreover, the process 300 may include other steps that are not shown here, and in fact, the process 300 is not limited to including every step shown in FIG. 3. The steps that are illustrated here as part of the process 300 are not limited to this particular chronological order. Indeed, some of the steps may be performed in a different order than what is shown and/or at least some of the steps shown can occur simultaneously. Process 300 will be discussed from the perspective of the MaaS system 110 of FIGS. 1 and 2.

At block 305, the MaaS system 110 may receive a request from a user 120 for an item to be picked up a point of origin and delivered to the user's destination. The point of origin may be the present location of the item or it may be a location where the item will be available for pick-up at a specified time. When sending an item pick-up request, the user may be in the same location as the item. Alternatively, the user and the item may be at different locations and the user may be in transit. The user's destination refers to a future location of the user. As an option, the user may enter his/her destination during the request. The user 120 may make the request via an application on a computing device 145 such as a desktop computer or a mobile device.

At block 310, the item association module 230 may associate the item 115 with the user 120. To associate the item 115 with the user 120, the user may check in the item 115 using the application to enter the relevant information. In such a case, when the application is opened and the MaaS system determines a user is checking in, a signal may be sent to the item association module 230. The item association module 230 may receive information about the user 120 and the item 115 as well as information that associates the item 115 with the user 120, as detailed above. Then, as example, the item association module 230 may create a user file in the data store 260 linking the user identifying data 270 with item data. In another example, the item association module 230 make create a database that includes metadata for each item. The metadata for each item may include characteristics of the item such as size, point of origin, destination and information about the related user. In such examples, the item association module 230 may create and output an identifier associating the user file/metadata and the item. Next, the computing device may print out the identifier 150 for the item 115 onto a label or tag, as an example, and the user 120 may then attach the label or tag to the item 115.

At block 315, the user destination module 240 may determine a destination of the user 120. The user destination module 240 may determine the destination of the user 120 based on user input. Alternatively, when the user 120 does not input a destination, the user destination module 240 may predict the user's destination. As an example, the user destination module 240 may determine and select a default destination based on the user's past usage and travel history. In such an example, the user destination module 240 may retrieve the user's file in the data store 260 and may scan through the user's history to determine which past destination the user 120 travels to the most. Alternatively, the user destination module 240 may determine which past destination the user 120 travelled to most recently. As another example, the user destination module 240 may determine what the item 115 is and based on that, the user destination module 240 may predict the user's destination. To determine what the item 115 is and what it is used for, the application may prompt the user 120 to enter what the item 115 is and what it is used for. Alternatively, the application may use a scanner (e.g., a camera) and an object identification (and related use) algorithm to determine what the item 115 is and what it is used for. Based on what the item 115 is and its use, the user destination module 240 may determine a related destination for the user 120. As an example, if the item 115 is a pair of skis, the user destination module 240 may determine that the user's destination is a ski resort. As another example, if the item 115 is camping equipment, the user destination module 240 may determine the user's destination is a camping site. The user destination module 240 may predict the user's destination by scanning through the user's calendar and/or schedule, identifying any activities or events scheduled for a time period that coincides with the pick-up time and/or dropoff time of the item 115, and identifying a location related to the identified activities or events. The user destination module 240 may select the location as the destination.

At block 320, the item delivery module 250 may determine a delivery route for the item 115 based at least on the destination. As described above, the item delivery module 250 maps out a delivery route for the item 115 using, as an example, any suitable mapping or navigational algorithm and based on the point of origin, the destination, available paths of travel and available MaaS vehicles.

At block 325, the item delivery module 250 may initiate delivery of the item 115 based on the determined delivery route by identifying and requesting a MaaS vehicle (e.g., MaaS vehicle 130, 135) pick up the item 115 at the point of origin.

At block 330, a user tracking device 125 may track movements of the user 120. As an example and as described above, the user tracking device 125 (such as a mobile device carried by the user or a watch worn by the user) may include a GPS that determines the user's movements. As another example, the user tracking device 125 may request information about the user's movements from the user. As another example, the user tracking device 125 may obtain the user's location based on travel logs of vehicles that the user has travelled in.

At block 335, the user destination module 240 may receive user movement data 275 based on at least the tracked movements of the user 120. In such a case, the user tracking device may constantly provide user movement data to the user destination module 240. Alternatively, the user tracking device may provide user movement data when the user's location changes.

At decision block 340, the user destination module 240 may determine whether the destination of the user 120 has changed based on the user movement data 275. As described above, the user destination module 240 may predict a change in destination if the user's movements are not along the route toward the destination. As an example, if the user 120 has to travel east on a route to the destination but the user destination module 240 determines the user is travelling west on the route, the user destination module 240 may determine that the destination of the user has changed. If the destination of the user 120 has changed, the process 300 may proceed to block 345. If the destination of the user 120 is unchanged, the process 300 may proceed to block 360.

At block 345, the user destination module 240 may update the destination of the user 120 based on the user movement data 275. The user destination module 240 may prompt the user 120 for a new destination. Alternatively, the user destination module 240 may predict the new destination based on the user's travel history as previously explained. The user destination module 240 may also predict the new destination based on places of interest located in the direction that the user 120 is travelling.

At block 350, the user destination module 240 may determine a revised delivery route for the item 115 based on the updated destination. Alternatively, and as detailed above, the user destination module 240 may communicate with the item delivery module 250 to determine a revised delivery route for the item 115 based on the updated destination. In either case, the user destination module 240 or the item delivery module 250 may apply any suitable mapping or navigational algorithm to determine the revised delivery route based on the item's current location, the updated destination, the available MaaS vehicles, and the available paths.

At block 355, the user destination module 240 may reroute the item based on the revised delivery route. Alternatively, the user destination module 240 may communicate with the item delivery module 250 to reroute the item 115, replacing a previous delivery route with a revised delivery route.

At block 360, the item delivery module 250 may initiate delivery of the item 115 based on the revised delivery route by identifying and coordinating an exchange between two MaaS vehicles. To coordinate the exchange, the item delivery module 250 may, as an example, request one MaaS vehicle drop off the item 115 at a depot and another MaaS vehicle pick up the item 115 at the depot to deliver the item 115 to the updated destination.

At decision block 365, the user destination module 240 may continually monitor whether the item 115 has been delivered. To determine whether the item 115 has been delivered, the user destination module 240 may monitor a status update of the item 115. Alternatively, the user destination module 240 may communicate with the RFID tag to determine if the item 115 has been delivered. If the item 115 has not been delivered, the process 300 may proceed to decision block 370. If the item 115 has been delivered, the process 300 may end.

At decision block 370, the user destination module 240 determines whether any of the delivery conditions has changed. Changes in delivery conditions may include change in destination, change in desired delivery period, change in traffic conditions along the delivery route, etc. If there are no changes in the delivery conditions, the process 300 may return to decision block 365. If there are changes in the delivery conditions, the process 300 may proceed to the block 375.

At block 375, the user destination module 240 may update the delivery conditions based on the changes in delivery conditions, and the process 300 may proceed to the decision block 340.

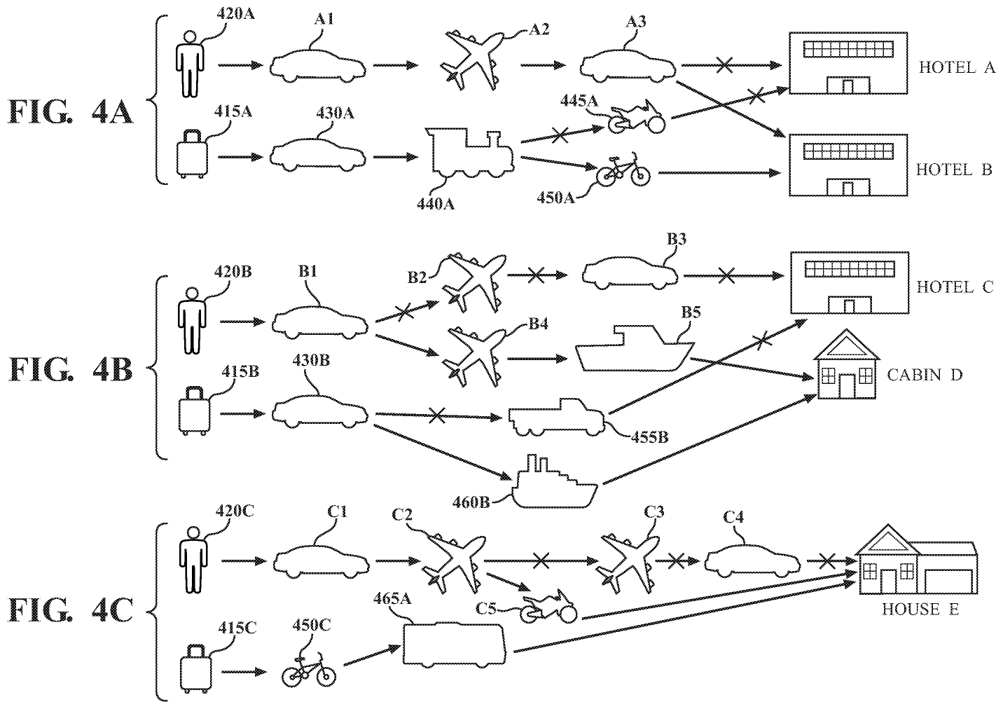

FIGS. 4A-4C illustrate example routes for the user 420A, 420B, 420C (collectively known as 420, and similar to the user 120 described above) and the item 415A, 415B, 415C (collectively known as 415, and similar to the item 115) where the destination of user 420 is updated and delivery route for the item 415 is revised. The travel route for the user 420 may include both MaaS and non-MaaS vehicles.

As shown in FIG. 4A, the user 420A is initially scheduled to travel to Hotel A. The original travel route for the user 420A includes a first automobile A1, followed by an airplane A2 and a second automobile A3. The original travel route for the luggage 415A includes three MaaS vehicles—an automobile 430A, followed by a train 440A and a motorcycle 445A. For the first two legs of the user's travel route, the user 420A travels by the first automobile A1, followed by the air plane A2. However, for the third leg, instead of going to Hotel A in the second automobile A3, the user travels in the second automobile A3 to Hotel B. The MaaS system 110 coordinates the item 415A pick-up by an automobile 430A, to be followed by the item 415A being transported by train 440A and motorcycle 445A. However, based on the user movement data 275, the MaaS system 110 may determine that the user 420A is no longer heading to Hotel A and is now heading to Hotel B. Upon determining a change in the user's destination, the MaaS system 110 updates the destination to Hotel B. Then, the MaaS system determines a revised delivery route based on the present location of the item 415A, the updated destination, etc. If the item 415A is currently in the train 440A, the MaaS system 110 may replace the motorcycle 445A heading to Hotel A with a bicycle 450A heading to Hotel B by cancelling the pick-up on the motorcycle 445A and requesting a pick-up by the bicycle 450A.

As shown in FIG. 4B, the user 420B is initially scheduled to travel to Hotel C. The original travel route of the user 420B includes a first automobile B1, followed by an airplane B2 and a second automobile B3. The original travel route for the luggage 415B includes two MaaS vehicles—an automobile 430B and a truck 455B. The user 420B travels by the first automobile B1, however, instead of travelling by airplane B2 and the second automobile B3, the user 420B travels by airplane B4 and by boat B5 to a cabin D. The MaaS system 110 coordinates the item 415B pick-up by the automobile 430B. Based on the user movement data 275, the MaaS system 110 determines the user 420B is not on airplane B2 and instead, the user 420B is on airplane B4. The MaaS system 110 may predict a new destination for the user 420B based on factors including a location airplane B4 is headed to, points of interest at the location, and user's travel history. As an option, upon determining a change in the destination, the MaaS system 110 may communicate with the user 420B to verify an updated destination. The MaaS system 110 updates the destination to cabin D. Then, the MaaS system 110 determines a revised delivery route based on the present location of the item 415B, the updated destination, etc. The MaaS system 110 may replace the truck 455B heading to Hotel C with a ferry 460B heading to cabin D. The MaaS system 110 may do that by cancelling the travel on the truck 455B and requesting a pick-up by the ferry 460B, which delivers the item 415B to cabin D.

As shown in FIG. 4C, the user 420C is initially scheduled to travel to a house E. The original travel route of the user 420C includes a first automobile C1, a first airplane C2, a second airplane C3, and a second automobile C4. The original travel for the luggage 415C includes two MaaS vehicles—a bicycle 450C and a bus 465A. The user 420C travels by the first automobile C1, then by the first airplane C2. However, instead of travelling by the second airplane C3 and the second automobile C4 to the house E, the user 420C travels by a motorcycle C5 to the house E. The MaaS system 110 coordinates the item 415C pick-up by the bicycle 450C. While the item 415C is on the bicycle 450C, the MaaS system 110 determines the user 120 did not board the second airplane C3 and may not be headed to the house E. However, the MaaS system 110 may determine that although the user 420C has changed routes, the user 420C is still heading to the house E based on, as an example, predicting a destination based on factors such as points of interest proximate to the user 420C, user's travel history, time of day, etc, or querying the user 420C for a new destination. Upon determining the destination is unchanged, the MaaS system 110 maintains the original delivery route for the item 415C, which is delivered to House E by the bus 465A.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for delivering an item, comprising:
associating, via a Mobility-as-a-Service (“MaaS”) system, the item with a user;
determining, by the MaaS system, a destination of the user;
determining, by the MaaS system, a delivery route for the item based at least on the destination;
initiating, using a MaaS vehicle, delivery of the item based on the determined delivery route;
tracking movements of the user;
receiving, by the MaaS system, user movement data based on at least the tracked movements of the user;
determining whether the destination of the user has changed based on the user movement data; and
if the destination of the user has changed,
updating the destination of the user based on the user movement data;
determining a revised delivery route for the item based on the updated destination; and
rerouting the item based on the revised delivery route.

2. The method of claim 1, further comprising:
when the destination of the user changes a plurality of times,
updating the destination of the user based on the user movement data for each of the plurality of times;
determining the revised delivery route for the item for each of the plurality of times; and
rerouting the item based on the revised delivery route for each of the plurality of times.

3. The method of claim 1, wherein associating the item with the user comprises:
checking in the item using a computing device.

4. The method of claim 1, wherein determining the destination of the user is based at least on user input.

5. The method of claim 1, wherein at least one of the determined delivery route and the revised delivery route comprises one or more sub-routes.

6. The method of claim 5, wherein the one or more sub-routes include at least one of a ground travel route, an air travel route and a water travel route.

7. The method of claim 1, wherein at least one of the determined delivery route and the revised delivery route for the item is further based on a desired delivery period.

8. The method of claim 1, wherein the tracked movements of the user are based on a navigation system integrated within a device associated with the user.

9. The method of claim 1, wherein the tracked movements of the user are based on at least one of user input and a database entry.

10. The method of claim 1, further comprising,
if the destination has not changed, delivering the item to the destination.

11. A Mobility-as-a-Service (“MaaS”) system for delivering an item, comprising:
a user tracking device, configured to track movements of a user;
one or more processors; and
a memory communicably coupled to the one or more processors and storing:
an item association module including instructions that when executed by the one or more processors cause the one or more processors to associate the item with the user;
a user destination module including instructions that when executed by the one or more processors cause the one or more processors to
determine a destination of the user; and
an item delivery module including instructions that when executed by the one or more processors cause the one or more processors to:
determine a delivery route for the item based at least on the destination; and
initiate delivery of the item based on the determined delivery route;
wherein the user destination module further includes instructions that when executed by the one or more processors cause the one or more processors to:
receive user movement data based on at least the tracked movements of the user;
determine whether the destination of the user has changed based on the user movement data; and
if the destination of the user has changed, update the destination of the user based on the user movement data; and
wherein the item delivery module further includes instructions that when executed by the one or more processors cause the one or more processors to
if the destination of the user has changed,
determine a revised delivery route for the item based on the updated destination; and
reroute the item based on the revised delivery route.

12. The MaaS system of claim 11, further comprising:
when the destination of the user changes a plurality of times,
the user destination module further includes instructions to update the destination of the user based on the user movement data for each of the plurality of times; and
the item delivery module further includes instructions to determine the revised delivery route for the item for each of the plurality of times, and reroute the item based on the revised delivery route for each of the plurality of times.

13. The MaaS system of claim 11, wherein the item association module further includes instructions to associate the item with the user by checking in the item using a computing device.

14. The MaaS system of claim 11, wherein the user destination module further includes instructions to determine the destination of the user based at least on user input.

15. The MaaS system of claim 11, wherein at least one of the delivery route and the revised delivery route comprises one or more sub-routes.

16. The MaaS system of claim 15, wherein the one or more sub-routes include at least one of a ground travel route, an air travel route and a water travel route.

17. The MaaS system of claim 11, wherein at least one of the determined delivery route and the revised delivery route for the item is further based on a desired delivery period.

18. The MaaS system of claim 11, wherein the tracked movements of the user are based on a navigation system integrated within a device associated with the user.

19. The MaaS system of claim 11, wherein the tracked movements of the user are based on at least one of user input and a database entry.

20. The MaaS system of claim 11, wherein the item association module further includes instructions to, if the destination has not changed, deliver the item to the destination.
